(19) United States
(12) Patent Application Publication
(10) Pub. No.: US 2010/0187236 A1
(43) Pub. Date: Jul. 29, 2010

(54) PROTECTIVE BULLETPROOF DEVICE FOR CONTAINER CONTAINING A LIQUID, AND CONTAINER PROVIDED WITH SAME

(75) Inventors: Benoit Le Rossignol, St. Jean De Braye (FR); Eric Forster, Nerville La Foret (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hutchinson

(21) Appl. No.: 12/628,528

(22) Filed: Dec. 1, 2009

(30) Foreign Application Priority Data
Dec. 2, 2008 (FR) 08/06757

(51) Int. Cl. B65D 90/06; F17C 13/12; F41H 13/00; F41H 5/007; B65D 88/12

(52) U.S. Cl. 220/560.02; 220/567.2; 89/36.02; 89/36.04; 220/562

(57) ABSTRACT

The invention relates to a Protective multilayer bulletproof device for attachment to an outer face of a wall of a container containing a liquid selected from the group consisting of motor fuels usable in normal temperature and pressure conditions, lubricating oils, hydraulic oils and heavy hydrocarbon solvents, and such a container provided with the said device.

This device comprises several layers of rubber respectively internal and more external for the wall whereof the outermost layer or at least one of the more external layers is made from cellular rubber for self-sealing a perforation of the wall by swelling in contact with the liquid, at least two of these adjacent layers being joined together by a fibrous interleaved structure.

According to the invention, the or each interleaved structure comprises at least one sheet based on nonwoven fibers which is absorbent to the said liquid and suitable for accelerating the diffusion of the absorbed liquid on the whole surface of the or each layer of cellular rubber in contact with the said sheet, for accelerating and increasing its swelling and for thereby obtaining the self-sealing in minimal time.

### CROSS REFERENCE TO RELATED APPLICATIONS

This application claims priority from French Application No. 08/06757, filed Dec. 2, 2008, which is hereby incorporated herein in its entirety by reference.

### FIELD AND BACKGROUND OF THE INVENTION

The present invention relates to a protective multilayer bulletproof device for attachment to an outer face of a wall of a container containing a liquid selected from the group consisting of motor fuels usable in normal temperature and pressure conditions, lubricating oils, hydraulic oils and heavy hydrocarbon solvents, and such a container provided with the said device. The invention applies to the self-sealing of perforations of containers caused by such shots, and particularly in the case in which these containers contain a diesel fuel for motor vehicles.

It has long been known how to protect gasoline tanks by providing their wall with multilayer self-sealing devices in case of perforation of the wall by the impact of a bullet, the self-sealing generally being obtained by the swelling of one or more layers of cellular rubber (that is, also called foam rubber) comprised by the device in contact with the gasoline that has leaked via the perforation. This is because this swelling, by the high and rapid increase in volume caused by the spread of the gasoline in the rubber (with a typical swelling rate of between 300 and 800% for natural cellular rubber), allows a nearly instantaneous plugging of the perforation and thereby prevents or minimizes the leakage of gasoline from the tank. One or more textile layers or sheets may be interleaved between these cellular rubber layers. Documents GB-545 504 and GB-A-2 054 457 can be cited for example for the description of such protective devices.

Document U.S. Pat. No. 4,336,291 also teaches the use of rubber layers which seal such perforations exclusively by elastic deformations of these layers that are joined together at spaced locations, without these layers necessarily being the seat of a swelling in contact with the fuel.

It is a major drawback of these known devices that they do not permit the rapid sealing of the tank in the case in which it does not contain gasoline but a heavier fuel, such as diesel for motor vehicles. In fact, diesel proves to have a much lower rate of spread in cellular rubber than gasoline, so that the cellular natural rubber swelling rate in diesel is typically between 100 and 200% and the perforation is sealed only after a few minutes, which is obviously unsatisfactory for minimizing the diesel leakage.

### SUMMARY OF THE INVENTION

It is an object of the present invention to propose a multilayer bulletproof device for attachment to an outer face of a wall of a container containing a liquid selected from the group consisting of motor fuels usable in normal temperature and pressure conditions, lubricating oils, hydraulic oils and heavy hydrocarbon solvents, which serves in particular to remedy this drawback, the said device comprising several layers of rubber respectively internal and more external for the wall whereof the outermost layer or at least one of the more external layers is made from cellular rubber for self-sealing a perforation of the wall by swelling in contact with the liquid, at least two of these adjacent layers being joined together by a fibrous interleaved structure.

For this purpose, a protective device according to the invention is such that the or each interleaved structure comprises at least one sheet based on nonwoven fibers which is absorbent to the said liquid and suitable for accelerating the diffusion of the absorbed liquid on the whole surface of the or each layer of cellular rubber in contact with the said sheet, for accelerating and increasing its swelling and for thereby obtaining the self-sealing in minimal time.

In the context of the present invention, “internal” layer of rubber means that of the rubber layers of the device adapted to be closest to the container wall, this internal layer preferably being made of cellular rubber but, if necessary, being made of a compact rubber.

In the context of the present invention, “more external” rubber layer(s) means the rubber layer or layers of the device which are located outside this internal layer after assembly on the container wall, whether it is the outermost layer in the case in which the device comprises only two layers of rubber, in which case this single outer layer is made from cellular rubber, or one or more intermediate layers in the preferred case in which the device comprises at least three layers of rubber, in which case at least the or each intermediate layer and/or the outermost layer of the device is/are made from cellular rubber.

It should be noted that this interleaved sheet according to the invention based on nonwoven fibers (i.e. exclusively or essentially consisting of these fibers, whereof the whole surface is in intimate contact with the two inner and outer layers, or between two intermediate layers or even between an intermediate layer and the outer layer, serves in case of perforation to absorb the abovementioned liquid very rapidly and throughout its mass, by generating a rapid surface contact with this liquid and over a large area of the rubber. This sheet based on nonwoven fibers thereby plays the role of a drain to bring the absorbed liquid instantaneously and in large quantities in contact with the adjacent cellular rubber, thereby causing a very rapid and substantial swelling of this cellular rubber and serving to seal the perforation in a few moments.

In particular, the or each nonwoven interleaved structure of the invention serves, surprisingly, to very significantly improve the swelling kinetics of the cellular rubber in contact with a diesel fuel absorbed by this structure, such as motor diesel, in comparison particularly with the swelling kinetics in contact with the same fuel, of this cellular rubber devoid of this nonwoven structure. The improvement in the swelling kinetics obtained is also valid for other fuels such as kerosene and gasoline and for heavy hydrocarbon such as lubricating oils and hydraulic oils.

According to another feature of the invention, the or each interleaved structure is suitable for absorbing a mass of the said liquid by capillarity, by immersion therein, which is higher than 200% of the mass of the said structure (that is twice its mass) before the said immersion.

It should be observed that this capillarity of the or each nonwoven structure according to the invention contributes significantly to increasing and accelerating its volumetric absorption of the liquid and its dissemination on the surfaces of the two opposite layers of rubber.

Advantageously, the or each interleaved structure may have a mass per unit area of between 50 g/m² and 200 g/m². It should also be observed that this reduced basis weight of the or each nonwoven structure, combined with its capillarity, serves to further improve the volumetric absorption and the surface dissemination of the liquid in contact with these rubber layers.

Preferably, the or each interleaved structure has a thickness of between 0.5 mm and 5 mm, the said or each sheet constituting same being formed of a nonwoven or an absorbent paper for example of the blotter type.

In the context of the present invention, “nonwoven” means a sheet obtained by joining fibers together by chemical or physical methods other than weaving and, in general, any structure, laminated or not, based on nonmetallic materials comprising at least one nonwoven, which can be defined as follows according to standard ISO 9092 of 1988. It may be a manufactured sheet, consisting of a voile fabric, a mat or a layer of fibers oriented directionally or at random, joined by friction and/or cohesion and/or adhesion. This nonwoven may be based on natural or chemical fibers which may be discontinuous fibers or continuous filaments.

The or each nonwoven according to the invention may comprise:
natural fibers, e.g. cellulose, and/or
organic or mineral artificial fibers (i.e. manufactured from products existing in nature having been subjected to chemical processing to obtain a textile or other material), such as viscose or glass fibers, and/or
synthetic fibers (i.e. manufactured entirely by chemical methods from derivatives of coal or oil), based on at least one polymer, such as a thermoplastic polymer of a textile or other type, e.g. a polyamide for example type PA6 or PA6.6, a polyester for example of the PET type or a polyolefin such as a polyethylene or a polypropylene.

Even more preferably, the or each interleaved structure consists of a single sheet formed of nonwoven having a mass per unit area of preferably between 150 g/m² and 200 g/m². This sheet may then be adapted for absorbing by capillarity a mass of the said liquid, by immersion therein, at least higher than 500% of the mass of the said structure (that is five times this mass) before the said immersion, in particular in the case of a diesel fuel.

Advantageously, the nonwoven forming this sheet may be based on polypropylene preferably answering to the trade name “OIL PAD 200” for absorbing by capillarity a mass of diesel fuel higher than 1000% of the mass of the said nonwoven (that is ten times its mass) before its immersion in the said fuel.

According to a further feature of the invention, each of the said layers of cellular rubber may consist of a composition of cross-linked and expanded rubber with open cells, preferably having a specific gravity of between 0.2 and 0.4.

It should be noted that the open cells formed in these layers serve to further accelerate their swelling in contact with the liquid disseminated by the adjacent nonwoven structure, in comparison with the same rubbers but having closed cells.

As to each of the layers of the device (that is both of the or each layer of cellular rubber and that of the or each optional layer of compact rubber), it is based on at least one elastomer which is preferably selected from the group consisting of natural rubber (NR), a polyisoprene (IR), a polychloroprene (CR), a styrene-butadine copolymer (SBR), a polybutadiene (BR), an isoprene-isobutylene copolymer (IIR), an ethylene-propylene-diene terpolymer (EPDM) and a blend of natural rubber with another of these elastomers such as for example a NR/SBR or NR/EPDM blend. As an alternative, this elastomer may be a silicone rubber, but this is non-limiting.

As to the thickness of each rubber layer, it is provided to be relatively thin, being about a few mm for example.

According to a preferred embodiment of the invention, these layers of cellular rubber are at least three in number and are connected together by at least two of the said interleaved structures, at least one intermediate layer and/or the outermost layer each forming the said layer of cellular rubber.

Even more preferably, all the rubber layers may be cellular, each consisting of a composition of cross-linked and expanded rubber with open cells based on natural rubber, but may be of the cellular type, optionally mixed with another elastomer such as a SBR or an EPDM.

It should be noted that the use of such cellular rubbers in all the rubber layers of the inventive device serve to further optimize the swelling thereof and hence the speed of the self-sealing of the perforation in comparison with a device incorporating one or more layers of compact (i.e. non-cellular) rubber.

It should also be noted that the use of natural rubber to constitute all or part of the elastomer matrix of each rubber composition represents a preferable embodiment of the invention, due to the particularly advantageous mechanical properties of natural rubber (such as its resistance to tearing and its resiliency) in comparison with those of other rubbers.

According to a further feature of the invention, the rubber layers of the device are joined together only at predefined points which are spaced at these layers, in order to promote their swelling in case of perforation. This joining is preferably obtained by mechanical means passing through all these layers at each of these points, such as staples, rivets or stitches, or as an alternative, by offset adhesive dots which are applied to each face of the or each interleaved structure in order to allow variable deformations of these layers from one layer to another.

Advantageously, the said outermost rubber layer may be surmounted, for example by bonding, by one or more outer coatings for example for increasing the mechanical strength, the stiffness and/or the fire resistance of the container.

A container according to the invention contains a liquid selected from the group consisting of motor fuels usable in formal temperature and pressure conditions, lubricating oils, hydraulic oils (e.g. for a power steering circuit or a braking circuit for a motor vehicle) and heavy hydrocarbon solvents, in particular a tank (being either static or dynamic if mounted on a vehicle) of a land, sea or air vehicle, a storage tank or road tanker, the container being bounded by a wall whereof one outer face is covered with a protective multilayer bulletproof device characterized as defined above.

As fuels answering to the abovementioned definition which are usable in the container according to the invention, mention can be made for example of gasoline or a diesel fuel for motor vehicles, fuel oil for marine or land vehicles, and kerosene for aircraft or for land vehicles.

According to another feature of the invention, this container may be such that the said internal layer of the device is bonded to this wall, which is optionally covered with an intermediate coating.

Advantageously, this container may be in particular a tank for a motor vehicle containing diesel fuel or gasoline, the said tank being made from metal, plastic or composite.

### BRIEF DESCRIPTION OF THE DRAWINGS

Other features, advantages and details of the present invention will appear from a reading of the following description of several exemplary embodiments of the invention, provided for illustration and non-limiting, the said description being provided in conjunction with the appended drawings in which:

FIG. 1 shows a partial schematic cross section of a protective device provided on a container according to an exemplary embodiment of the invention,

FIG. 2 shows a partial schematic cross section of a protective device provided on a container according to an alternative embodiment of the invention,

FIG. 3 shows a partial schematic cross section of a protective device provided on a container according to another alternative embodiment of the invention, and

FIG. 4 is a graph showing the change over time (in minutes) of the relative variation in mass (in %) of three interleaved structures according to the invention of the nonwoven sheet type, in comparison with that of a cellular rubber test specimen.

### MORE DETAILED DESCRIPTION

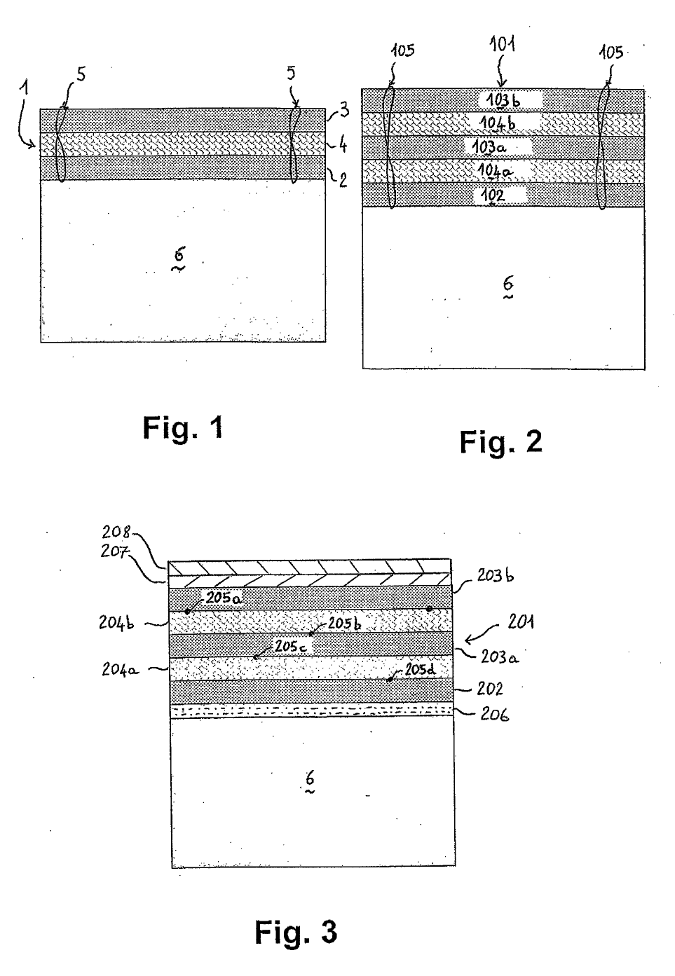

The protective device 1 shown in the example in FIG. 1 comprises two layers of cellular rubber respectively internal 2 and external 3 both having open cells, each preferably being based on low-filler natural rubber having a specific gravity close to 0.3, these two layers 2 and 3 being applied on either side of an interleaved sheet 4 based on nonwoven fibers which is preferably a polypropylene nonwoven having the trade name “OIL PAD 200”. These layers 2 and 3 surrounding the sheet 4 are joined together in this example by staples, rivets or stitches 5 passing through both of them at spaced (uniformly or not) locations at these layers 2 and 3. As to the internal layer 2, it is bonded directly to the wall 6 of the container (made from metal or plastic) such as a diesel or gasoline tank for motor vehicle, a fuel oil tank for marine or land vehicle, or a kerosene tank for aircraft or land vehicle, for example.

After obtaining these two cross-linked and expanded layers 2 and 3 separately, the device 1 is prepared by joining these layers 2 and 3 on either side of the sheet 4, as indicated above. It should be noted that this nonwoven sheet 4 here is joined to the layers 2 and 3 without adhesion or bonding.

The protective device 101 shown in FIG. 2 is only different from that in FIG. 1 in that it comprises a third intermediate layer 103a between its internal 102 and external 103b layers, on either side of which two interleaved sheets 104a and 104b are applied, each formed for example of the same nonwoven “OIL PAD 200”. The combination of these three layers 102, 103a and 103b and these sheets 104a and 104b is joined together by staples, rivets or stitches 105 as in FIG. 1.

The protective device 201 shown in FIG. 3 is different from that in FIG. 2 in that:
the three rubber layers 202, 203a and 203b and the two sheets 204a and 204b interleaved alternately between them are joined by offset adhesive dots 205a, 205b, 205c and 205d (i.e. not aligned in a cross section) which are applied to each of the two faces of each nonwoven sheet 204a, 204b,
the internal rubber layer 202 is bonded to an intermediate coating (206) for example made from plastic, which is provided on the wall 6 of the container, and in that
the outer rubber layer 203b is surmounted by bonding a mechanical protection coating 207 preferably based on high tenacity polyethylene (PENT) for example having the trade name “DYNEEMA”, which am is covered with an outer coating 208 for stiffening and fire resistance, preferably based on a polyurethane which shrinks during the cross-linking, in order to form a stiff and fire resistant casing for the container.

The Applicant has demonstrated in particular that the interleaved sheets 4, 104a, 104b, 204a and 204b in the devices 1, 101, 201 according to FIGS. 1 to 3 serve in case of perforation to absorb the diesel very rapidly and throughout their mass with a rapid surface contact over a large area of the diesel with the rubber, thereby increasing and accelerating the swelling thereof in comparison with the same rubber devoid of these sheets.

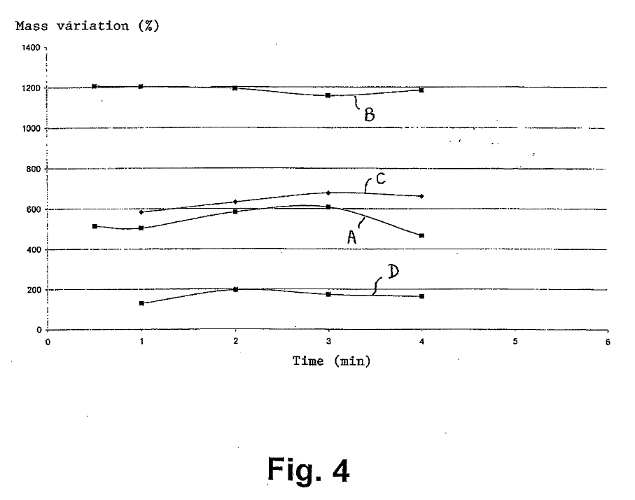

To illustrate this statement, the Applicant has conducted two series of tests consisting in the following:
for the first series of tests, in taking comparative measurements of the relative variation in mass, following an immersion in gasoline and in diesel, of a cross-linked and non-expanded rubber composition based on natural rubber (i.e. a compact rubber) and a cross-linked rubber composition having the same formulation but expanded by a swelling agent in order to have open cells;
for the second series of test (the results of which are shown in FIG. 4) in taking comparative measurements of the relative variation in mass, following an immersion in diesel, of three sheets formed respectively of three nonwovens according to the invention based on polypropylene and a cross-linked rubber composition based on natural and expanded rubber having open cells.

### First Series of Tests:

The method followed for determining the variation in mass was a method derived from the method described in standard NFT 46-013.

The test conditions were as follows:

| | |
|---|---|
| Immersion time | 5 min. |
| Fuel temperature | 23° C. |
| Test specimen dimensions | 20 × 20 × 4 mm³ |
| Mass reading | 1 min. after end of immersion |
| Fuels tested | gasoline and diesel (standard) |
| Number of tests per fuel | 3 tests |

Each test specimen was weighed on a balance accurate to +/− 0.1 mg, and then immersed in a container filled with fuel at the selected temperature (here 23° C.) and having a device for keeping the low density specimens submerged. The timer was started, and each specimen taken out after 5 minutes of immersion. Each specimen was then gently dabbed to remove the liquid from its surface and then placed on the tray of a balance accurate to +/−0.1 mg. Its mass was recorded in the sixth minute, and its relative variation in mass ΔM then calculated by the formula ΔM=(M_{f}−Mᵢ)/Mᵢ×100, where

Mᵢ and M_{f} are respectively the initial and final masses of each test specimen.

The following average values were obtained for ΔM:

a) After immersion in gasoline:

V=14.3% for compact rubber specimens, and

V=500% for cellular rubber specimens; and

b) after immersion in diesel:

V=4.6% for compact rubber specimens, and

V=120% for cellular rubber specimens.

These values illustrate, on the one hand, the superiority of the cellular rubber over the compact rubber for its swelling by absorption in contact with one or the other of the two fuels and, on the other hand, the lower diesel absorbance of the cellular and compact rubbers in comparison with gasoline.

### Second Series of Tests:

The change over time and relative variation in mass ΔM, were observed after immersion at 23° C. in standard diesel (available at a TOTAL service station) of the abovementioned three nonwovens, in comparison with the relative variation V in mass of a test specimen consisting of a cross-linked and expanded rubber composition with the trade name “NR V194C5” (based on natural rubber with open cells). The abovementioned formula was used to calculate ΔM, where M_{f} is the mass of a test specimen considered at time t (ranging from 0.5 min. to 4 min.).

Curve A shows the change over time in V for a polypropylene nonwoven sheet having the trade name “SB40E/O/S”, curve B for a polypropylene nonwoven sheet “OIL PAD 200”, curve C for another polypropylene nonwoven sheet and curve D for the specimen consisting of the rubber composition “NR V194C5”.

The graph in FIG. 4 shows that the preferred nonwoven “OIL PAD 200” absorbs about 1200% of its mass (or twelve times its mass) very rapidly, or six times more than the cellular rubber specimen. As explained above, this rapid absorption of the diesel by this nonwoven allows its very rapid dissemination over a large area of the rubbers in contact with the nonwoven, an area much larger than that of the lateral surface of a perforation due to the impact of a bullet, thereby enabling each adjacent rubber to swell and hence generate the desired self-sealing effect.

1. A protective multilayer bulletproof device for attachment to an outer face of a wall of a container containing a liquid selected from the group consisting of motor fuels usable in normal temperature and pressure conditions, lubricating oils, hydraulic oils and heavy hydrocarbon solvents, the device comprising several layers of rubber respectively internal and more external for the wall whereof the outermost layer or at least one of the more external layers is made from cellular rubber for self-sealing a perforation of the wall by swelling in contact with the liquid, at least two of these adjacent layers being joined together by a fibrous interleaved structure, characterized in that the or each interleaved structure comprises at least one sheet based on nonwoven fibers which is absorbent to the said liquid and suitable for accelerating the diffusion of the absorbed liquid on the whole surface of the or each layer of cellular rubber in contact with the said sheet, for accelerating and increasing its swelling and for thereby obtaining the self-sealing in minimal time.

2. A protective device according to claim 1, characterized in that the said or each interleaved structure is suitable for absorbing a mass of the said liquid by capillarity, by immersion therein, which is higher than 200% of the mass of the said structure before the said immersion.

3. A protective device according to claim 1, characterized in that the said or each interleaved structure has a mass per unit area of between 50 g/m² and 200 g/m².

4. A protective device according to claim 1, characterized in that the said or each interleaved structure has a thickness of between 0.5 mm and 5 mm, the said or each sheet constituting same being formed of a nonwoven or an absorbent paper.

5. A protective device according to claim 4, characterized in that the said or each interleaved structure consists of a single sheet formed of nonwoven having a mass per unit area of between 150 g/m² and 200 g/m².

6. A protective device according to claim 5, characterized in that the said or each interleaved structure is suitable for absorbing a mass of the said liquid by capillarity, by immersion therein, which is higher than 500% of the mass of the said structure before the said immersion.

7. A protective device according to claim 6, characterized in that the said nonwoven is based on polypropylene, preferably answering to the trade name “OIL PAD 200” for absorbing by capillarity a mass of diesel fuel higher than 1000% of the mass of the said nonwoven for its immersion in the said fuel.

8. A protective device according to claim 1, characterized in that each of the said layers of cellular rubber consists of a composition of cross-linked and expanded rubber with open cells having a specific gravity of between 0.2 and 0.4.

9. A protective device according to claim 1, characterized in that each of the said layers of cellular rubber is based on at least one elastomer which is:
selected from the group consisting of natural rubber (NR), a polyisoprene (IR), a polychloroprene (CR), a styrene-butadiene copolymer (SBR), a polybutadiene (BR), an isoprene-isobutylene copolymer (IIR), an ethylene-propylene-diene terpolymer (EPDM) and a blend of natural rubber with another of these elastomers, or:
a silicone rubber.

10. A protective device according to claim 1, characterized in that the said layers of cellular rubber are at least three in number and are connected together by at least two of the said interleaved structures, at least one intermediate layer and/or the outermost layer each forming the said layer of cellular rubber.

11. A protective device according to claim 1, characterized in that each of the said layers of rubber is cellular, consisting of a composition of cross-linked and expanded rubber with open cells based on natural rubber, optionally mixed with another elastomer such as a SBR or an EPDM.

12. A protective device according to claim 1, characterized in that the said layers of cellular rubber are joined together only at predefined points which are spaced at these layers, in order to promote their swelling in case of perforation.

13. A protective device according to claim 12, characterized in that the said layers of rubber are joined together by mechanical means passing through them at each of the said predefined points.

14. A protective device according to claim 12, characterized in that the said layers of rubber are joined by offset adhesive dots which are applied on each of the two faces of the or each interleaved structure, so as to allow variable deformations in these layers from one layer to another.

15. A protective device according to claim 1, characterized in that the said outermost rubber layer is surmounted by bonding, by one or more outer coatings for example for increasing the mechanical strength, the stiffness and/or the fire resistance of the container.

16. A container containing a liquid selected from the group consisting of motor fuels usable in formal temperature and pressure conditions, lubricating oils, hydraulic oils and heavy hydrocarbon solvents, in particular a tank of a land, sea or air vehicle, a storage tank or road tanker, the container being bounded by a wall whereof one outer face is covered with a protective multilayer bullet device characterized in that the said device is according to claim 1.

17. A container according to claim 16, characterized in that the said internal layer of the protective device is bonded to the said wall, which is optionally covered with an intermediate coating.

18. A container according to claim 16, characterized in that it is a tank for a motor vehicle containing diesel fuel or gasoline, the said tank being made from metal, plastic or composite.

19. A container according to claim 17, characterized in that it is a tank for a motor vehicle containing diesel fuel or gasoline, the said tank is being made from metal, plastic or composite.
